(19) United States
(12) Patent Application Publication
(10) Pub. No.: US 2017/0370630 A1
(43) Pub. Date: Dec. 28, 2017

(54) METHOD AND APPARATUS FOR COOLING A CHILLED-GOODS CONTAINER

(71) Applicant: Sell GmbH, Herborn (DE)

(72) Inventors: Samuel KLASSEN, Haiger (DE); Dominik Marius MAEMPEL, Marburg (DE)

(21) Appl. No.: 15/527,739

(22) PCT Filed: Jan. 28, 2016
(86) PCT No.: PCT/EP2016/051826

§ 371 Date: Jun. 23, 2017

Related U.S. Application Data
(60) Provisional application No. 62/108,620, filed on Jan. 28, 2015.

(51) Int. Cl. F25D 11/00; F25D 15/00; F25D 17/06

(52) U.S. Cl. CPC F25D 11/003; F25D 2500/02; F25D 2400/38; F25D 2400/20; B62B 2202/67; F25D 17/06; F25D 15/00; B62B 2204/04; F25D 2317/0671

(57) ABSTRACT

Disclosed is a cooling device (1), in particular for a galley of an aeroplane, comprising a cooling compartment (2) formed by inner walls (12, 13, 14, 15) of the cooling device, holding at least one refrigerated goods container (20), in particular a trolley, and further comprising a cooling air feed device (3) for introducing cooled air into the cooling compartment and a hot air discharge device (4) for discharging heated air (98) from the cooling compartment, wherein a primary flow channel is configured in use with the at least one refrigerated goods container (20) in the cooling compartment (2) between the inner walls (12, 13, 14, 15) of the cooling device and outer walls (22, 23, 24, 25) of the at least one refrigerated goods container (20), to guide a cooling air flow along a primary flow direction, deflected a plurality of limes through the arrangement of inner walls, from the cooling air feed device (3) around the at least one refrigerated goods container (20) to the hot air discharge device (4). According to the invention, the cooling air feed device (3) is configured to introduce the cooled air as jets into the primary flow channel along the primary flow direction (x), and in the cooling compartment (2) a secondary flow channel (9) is configured to return, as a secondary flow (9A), a portion (9A) of the cooling air flow guided through the primary flow channel around the at least one refrigerated goods container (20) into the primary flow channel for the purpose of mixing the introduced cooled air and forming a circulation flow (97) around the at least one refrigerated goods container (20) along the primary flow direction (x).

The present invention relates to a cooler of the type according to independent claim 1. The object of the invention is also a method of cooling a refrigerated-goods container.

### PRIOR ART

It is a long-established practice to transport cooled foods and beverages in aircraft as refrigerated goods for consumption during the flight. These refrigerated goods are brought on board in refrigerated-goods containers, also called trolleys, and cooled continuously by chilled air flowing around them in coolers in the on-board kitchen, also called a galley. Such coolers are primarily intended for cooling refrigerated goods or, more particularly, keeping them cold, and not for cooling the refrigerated goods off or down.

Such a cooler, which is shown in FIG. 23 by way of example, comprises a cooling compartment 2 that is formed by inner walls 12 to 15 of the cooler 1, and into which, upon opening a door of the cooler, one or more refrigerated-goods containers 20 are introduced, for example by rolling or pushing. Flow passages for flowing cool air around the refrigerated-goods container are formed by the inner walls 12 to 15 of the cooler spaced from and parallel to respective outer walls 22 to 25 of the cooling compartment 2 of the refrigerated-goods container 20 received in the cooling compartment. A cool-air input device 3S at the upper end of the cooler in FIG. 23 by way of example, circulates cool air 5S into the cooling compartment 2 at a rate of flow of usually about 3.5 m/s such that the cool air, on the one hand, after it is introduced, flows along a first long flow path S1 from an upper-side wall 22, over a front-side wall 23 facing away from the cool-air input device, and along a lower-side wall 24 of the refrigerated-goods container to a hot-air extractor 4S of the cooler that removes the heated air 98 from the cooling compartment, and that the cool air, on the other hand, after it is introduced, also flows, or rather sinks, along a second, short flow path S2 on a rear-side wall 25 of the refrigerated-goods container facing toward the cool-air input device to the hot-air extractor 4S of the cooler. In order to enable a sufficient amount of cool air to be introduced on the first, long flow path S1 for cooling and prevent the cool air that is introduced from flowing out over the shorter second flow path S2 to the hot-air extractor without effectively cooling the refrigerated-goods container, a seal 19 or a seal gap 19S is provided in the second flow path S2 near the hot-air extractor, for example, in order to restrict the second, short flow path S2. The correct dimension of this restriction and hence the dimensioning of the seal 19 as well are crucial for the uniform and efficient cooling of the refrigerated-goods container. If the second, short flow path S2 is restricted too much by the seal 19, the rear-side wall of the refrigerated-goods container facing toward the cool-air input device may not be cooled sufficiently. On the other hand, if the restriction of the second flow path S2 is insufficient, the walls of the refrigerated-goods container are not cooled sufficiently along the first, long flow path S1, and the air guided over the second, short flow path S2 is discharged over the hot-air extractor and out of the cooling compartment without having been used efficiently as relatively cool air. Since the seal 19 is between and movable relative to an inner wall 5 of the cooler and a rear-side wall 25 of the refrigerated-goods container 20 introduced into the cooling compartment, the degree of restriction of the second flow path S2 effected by the seal 19, and hence the uniform cooling of the walls of the refrigerated-goods container as well, cannot be set with precision and is subject to pronounced fluctuations, intensified by effects of aging of the seals, blockage of the seal gap 9S by dirt, and possible damage on introduction of the refrigerated-goods container.

### OBJECT OF THE INVENTION

It is therefore the object of the present invention to provide a cooler and a corresponding method of cooling that ensure the uniform cooling of the walls of the refrigerated-goods container over a long expected useful life of the cooler with a great number of introductions of refrigerated-goods containers into the cooler. Moreover, a more efficient use of the cool air introduced and thus a more efficient transfer of energy from the refrigerated-goods container to the air flowing past it and thus heated is desired.

The object of the invention is attained by a cooler with the features of claim 1 in combination with at least one refrigerated-goods container provided for the cooler. The at least one refrigerated-goods container is particularly suitable for a transport container provided for airplane transport for storing foods and/or beverages, such as a so-called trolley, for example, equipped with wheels that are mounted on the lower-side wall or bottom wall thereof or facing toward same, and can thus be rolled into the cooling compartment, a so-called standard unit, or also a beverage box, such as a wine box, for example. For the present invention, it is assumed—without constituting a restriction—that the at least one refrigerated-goods container corresponds in its dimensions and its other design aspects to the standard for containers intended for aircraft transport and meets the requirements of such a standard.

The cooler presented herein has a cooling compartment defined by inner walls of the cooler for receiving at least one refrigerated-goods container, as well as a cool-air input device for introducing cool air into the cooling compartment and a hot-air extractor for removing heated air from the cooling compartment. Furthermore, the cooler is formed such that, when used in conjunction with the at least one refrigerated-goods container in the cooling compartment between the inner walls of the cooler and outer walls of the at least one refrigerated-goods container, a primary flow passage for guiding a cool-air stream along a primary flow direction multiply deflected by the arrangement of the inner walls from the cool-air input device around the at least one refrigerated-goods container to the hot-air extractor is formed. The cool-air input device introduces the cool air into the primary flow passage along the primary flow direction in the form of a stream. Moreover, the cooler is formed such that a secondary flow passage is formed in the cooling compartment in order to return, as a secondary flow, a portion of the cool-air stream guided by the primary flow passage around the at least one refrigerated-goods container to the primary flow passage for the purpose of mixing with the introduced cool air and forming a circulation flow around the at least one refrigerated-goods container along the primary flow direction. The circulation flow follows a circuit that is closed in the manner of a ring in the primary flow direction, apart from the fact that a portion of this circulation flow is removed from the cooling compartment by the hot-air extractor.

As a result of the stream-like introduction of the cool air into the primary flow passage along the primary flow direction—this also includes the introduction of cool air through a stream that is angled relative to the primary flow direction, on the condition that no cool air is introduced by such a stream into the primary flow passage counter to the primary flow direction; in other words, the direction of the introduced stream corresponds substantially to the primary flow direction—at a high rate of flow, the working area of the stream (the term “stream” is also understood as referring to several stream segments) impedes the entry of cool air into the secondary flow passage against the primary flow direction, and negative pressure and hence a suction effect occurs in the secondary flow passage or at the downstream-side outlet thereof and transition to the primary flow passage. As a result of the suction effect that propagates from the outlet of the secondary flow passage to the inlet thereof, a portion of the air flowing toward the hot-air extractor is deflected in the direction of the inlet of the secondary flow passage, whereas the remaining portion is discharged from the cooling compartment by the hot-air extractor as heated air. The cooler is preferably designed to introduce the cool air into the primary flow passage along the primary flow direction at a rate of flow of at least 5.0 m/s, especially preferably at least 7.5 m/s.

Regarding the concept of the deflected primary flow direction and deflection of the primary flow direction, it is understood for the present invention that a real deflection of the airflow by relatively small angles, for example no more than 25°, preferably 20°, especially preferably 10°, and/or the formation of a local eddy in the airflow in the primary flow passage does not constitute a deflection of the primary flow direction. For example, for a cooler with an approximately parallepipedal cooling compartment in which at least one approximately parallepipedal refrigerated-goods container is received, the deflection of the primary flow direction is understood rather as referring to the fact that the primary flow direction experiences a deflection in the transition from an inner wall of the cooling compartment to the (in relation to the airflow in the primary flow passage) downstream inner wall of the cooling compartment. In an approximately parallepipedal cooling compartment, the deflection of the primary flow direction occurs in the corners—that are understood as also including rounded corners—of the cooling compartment and, for this example, corresponds to a deflection of the airflow in the primary flow passage that is substantially at a right angle, i.e., in the range from about 80 to 100°.

Furthermore, the inventive design of the cooler enables the uniform cooling of all flowed-around outer surfaces of the at least one refrigerated-goods container without the arrangement of a seal or similar flow restriction means between an inner wall of the cooler and an outer wall of the at least one refrigerated-goods container that can be moved relative thereto. The cooler presented herein is thus formed without such a seal in the primary flow passage or secondary flow passage.

Moreover, the cooler presented herein enables cool air having a large temperature difference from the air flowing in the cooling compartment to be introduced without large temperature differences occurring in the cooling compartment or on the surfaces of the at least one refrigerated-goods container. To wit, the circulation flow induced by the secondary flow brings about a uniform temperature distribution in the cooling compartment. Since the cool air can be introduced with a greater temperature difference, the volumetric flow rate required for cooling and hence also corresponding pressure losses in the flow passages in the cooling compartment are reduced. With the reduction of the throughput, a reduction of the noise generation caused by the fans used to move the air can also be advantageously achieved. For example, foods must usually be maintained at a temperature of no more than 4° C. Disregarding the temperature difference in relation to the at least one refrigerated-goods container, the maximum temperature in the cooling compartment is thus 4° C. Now, if air having a temperature of 0° C. is fed into the cooling compartment, an average temperature of 2° C. is achieved using the conventional technique. In the proposed cooler, assuming, for example, that half of the air is discharged and the other half circulates, the temperature of the air is 2° C. after mixing and not 0° C. The average temperature is thus increased to 3° C. Since the heat losses via the walls of the cooler are directly proportional to the temperature difference, a higher average temperature in the cooling compartment and thus a lower temperature difference in relation to the surroundings is advantageous as a matter of principle.

Another way of looking at this is the maintaining of the temperature difference in the cooling compartment. Continuing with the above example, with the proposed cooler, the cool air can be fed in at a temperature of −4° C. With conventional technology, this would not be worthwhile, because foods or beverages in the vicinity of the cooling air feed could otherwise be frozen. In contrast, in the cooler proposed herein, the mixing of the circulation flow and the introduced cool air results in a temperature of 0° C., and 2° C. is produced as the average temperature in the cooling compartment. For the temperature difference between the intake air and the exhaust air, however, this results in an increase from 4K to 8K. Consequently, the same cooling capacity can be provided at half the volumetric flow rate. This reduces the losses in the cooling passages to ¼, since pressure losses are proportional to the volumetric flow rate and the speed squared. In practice, these advantages cannot be exploited 100%, but they do prove to be fundamental advantages.

In well insulated galleys in which heat losses via the outer walls are of only little consequence and, due to the smaller need for cooling, the volumetric flow rate with cold air is also reduced, this results in a disadvantage for the cooling of the trolley or trolleys, since the need for cooling cannot be reduced by the insulation. By virtue of the proposed cooler, the temperature of the introduced cool air or intake air can be reduced without one side of the refrigerated-goods container becoming too cold, and the volumetric flow rate around the trolley can be increased, whereby the cooling capacity for the cooling of the trolleys can be raised to a higher level. This means, in turn, that more capacity can be drawn from the cooling for the cooling period. While this is less efficient for the cool-air input device with a chiller that supplies cold air, it increases the cooling capacity for the relatively short cooling operation.

In relation to the present invention, the term “air” is used generally to refer to any fluid that is suitable for the transmission of thermal energy and flowing through the primary flow passage and the secondary flow passage, and particularly air from the atmosphere and/or a gaseous air mixture such as those generally used today in aircraft to cool trolleys in the on-board kitchen.

In a development of the proposed cooler, a provision is made that the primary flow passage and the secondary flow passage form together a circulation flow passage for the circulation of the secondary flow together with the primary flow around the at least one refrigerated-goods container. The circulation flow passage is thus formed as a result of the secondary flow passage interconnecting the two ends of the primary flow passage.

In a development of the proposed cooler, a provision is made that the cool-air input device and the hot-air extractor are spatially on one or two of the inner walls of the cooler so as to be adjacent to one another. Through this mutually adjacent arrangement of the cool-air input device and the hot-air extractor, the flow path in the primary flow direction from the cool-air input device to the hot-air extractor is maximized and the heat absorption capacity of the air flowing around the at least one refrigerated-goods container is also utilized optimally, since the volumetric rate of flow in the primary circuit is always greater that the volumetric rate of flow in the circulation circuit. The cool-air input device and the hot-air extractor can be mounted on any inner wall of the cooler, such as the top wall, rear wall, or the bottom, for example, as well as on the inside of the door for opening the cooler for the purpose of introducing the at least one refrigerated-goods container.

In a continuation of this development, a provision can be made that the cool-air input device or the hot-air extractor is on two mutually adjacent inner walls for deflecting the primary flow direction, that is, in a corner of the cooler, for example. The primary flow direction of the circulation flow can then be deflected in a loss-optimized manner by feeding the heated air in the primary flow direction to the hot-air extractor before deflection, upon which the cool-air input device introduces the cool air in the primary flow direction into the primary flow passage after the desired deflection.

In addition, for this or another development of the proposed cooler, a provision can be made that the cool-air input device and the hot-air extractor form a combined air feed/air discharge duct. This enables the especially space-saving accommodation of the cool-air input device and the hot-air extractor as well as the ducts associated therewith in the cooler. Moreover, the combination of feed air and exhaust air in a combined passage is more cost-effective and easier.

What is more, a provision is made in one development of the proposed cooler that the secondary flow passage is formed by one of the outer walls of the at least one refrigerated-goods container and an outer wall of the hot-air extractor and/or an outer wall of the cool-air input device. In this way, the secondary flow passage can be easily formed through the introduction of the at least one refrigerated-goods container into the cooling compartment into a storage position provided for the at least one refrigerated-goods container. A secondary flow passage formed by an outer wall of the at least one refrigerated-goods container and an outer wall of the hot-air extractor enables the space-saving and efficient creation of a unit for dividing the heated air flowing through the primary flow passage into a portion that is conducted for the purpose of circulation through the secondary flow passage and a portion that is discharged from the cooling compartment by the hot-air extractor.

Furthermore, a provision is made in one development of the proposed cooler that the secondary flow passage is formed by an intermediate wall provided in the cooling compartment and an outer wall, spaced apart therefrom, of the hot-air extractor and/or outer wall of the cool-air input device. The intermediate wall is preferably provided in the cooling compartment even without a refrigerated-goods container inserted in the cooling compartment and can be mounted securely in the cooling compartment at a distance to the opposing outer wall of the hot-air extractor and/or cool-air input device. The intermediate wall can be provided as a stop buffer and/or fixing means for the at least one refrigerated-goods container such that, when used in conjunction with the at least one refrigerated-goods container between the intermediate wall and an outer wall adjacent thereto of the at least one refrigerated-goods container, no secondary flow can pass. Alternatively, the intermediate wall can be mounted in the cooling compartment such that, when used in conjunction with the at least one refrigerated-goods container between the intermediate wall and an outer wall adjacent thereto of the at least one refrigerated-goods container, an additional secondary flow passage is formed. Moreover, a provision is preferably made for the cooler that the inner walls of the cooler forming the cooling compartment are designed to guide the cool-air stream along the primary flow direction with multiple deflection of the primary flow direction by the arrangement of the inner walls. This enables a simple, wear-resistant, and energy-efficient design of the cooling compartment without additional guiding and deflecting walls.

In a development of the proposed cooler, a provision is also made that the cool-air input device introduces the cool air as a stream or as a plurality of streams in an upstream part of the primary flow passage over an entire width and an entire height of the primary flow passage in the upstream part, and that the upstream part is formed without a deflection of the primary flow direction by the arrangement of the inner walls of the cooler. Given that, in at least one position of the upstream part, the cool air fills out the primary flow passage completely in its cross section defined by its width and height, an optimized suction effect is achieved on the side of the stream or streams facing away from the primary flow direction, i.e., “behind” the introduction position of the cool air, so that the air of the secondary flow flowing out of the secondary flow passage is mixed with the cool air but the cool air cannot get into the secondary flow passage immediately opposite the primary flow direction. In this way, it is ensured that the circulation flow along the primary flow direction around the refrigerated-goods container and the suction at the outlet of the secondary flow passage are produced at every position of the cross section of the upstream part.

In a continuation of this development of the proposed cooler, a provision is made that an airflow guiding wall for conducting the introduced cool air is in the upstream part and that the airflow guiding wall, when used in conjunction with the at least one refrigerated-goods container, is adjacent thereto. The airflow guiding wall preferably extends along the primary flow direction provided in the upstream part. Furthermore, the airflow guiding wall is preferably such that a flow boundary of a free jet of introduced cool air strikes the airflow guiding wall. The airflow guiding wall can also be in combination with the abovementioned intermediate wall provided to form the secondary flow passage. The airflow guiding wall and the intermediate wall can then be separated spatially from one another. It is preferred, however, that the airflow guiding wall and the intermediate wall be adjacent to each other or as a common component. With the airflow guiding wall, the introduced cool air can be introduced in an optimized manner into the upstream part independently of the surface structure of the at least one refrigerated-goods container. It is thus possible, for example, to prevent a grip of the at least one refrigerated-goods container positioned in the upstream part from causing a local swirling of the introduced cool air. A combination of an airflow guiding wall and intermediate wall substantially at a right angle to one another also enables the optimized designing of the upstream part and of the secondary flow passage independently of the respective neighboring surface of the refrigerated-goods container and, what is more, it can also act as a guiding and holding device upon introduction of the refrigerated-goods container into the cooling compartment.

As another continuation of the above development or continuation, a provision can be made that a flow boundary of the stream or flow boundaries of the plurality of streams is or are facing toward the secondary flow passage and completely fills or fill out at least one plane perpendicular to the primary flow direction in the upstream part. The stream or the plurality of streams are each formed as a free jet with a flow boundary. The flow boundary is determined by a spread angle or expansion angle, particularly in the range from 18 to 37°, preferably in the range from 24 to 33°, depending on the shape of the respective outlet port of the cool-air input device. The respective flow boundary corresponds to the areas in which the air surrounding the stream is entrained by the stream. The stream width becomes greater as the distance from the respective outlet port increases, until the respective stream—preferably without deflection of the primary flow direction or at least with deflection that does not exceed 25°—finally strikes a wall in the upstream part that partially forms same, that is, an inner wall of the cooler or an outer wall of the at least one refrigerated-goods container. The expression “without deflection of the primary flow direction” means especially preferably that the primary flow direction remains unchanged but does not generally exclude a real deflection of the airflow by a relatively small angle, for example no more than 25°, preferably 20°, especially preferably 10°, and/or the production of local swirling in the primary flow passage, e.g., at a head or rivet projecting into the primary flow passage. As a result of the fact that the flow boundary or flow boundaries faces or face toward the secondary flow passage, more particularly the outlet of the secondary flow passage, in the upstream part and completely fills or fill out a plane perpendicular to the primary flow direction in the upstream part, only air merging from the secondary flow passage is mixed with the introduced cool air.

Moreover, in a development of the proposed cooler, a provision is made that the cool-air input device introduces the cool air as a stream or as a plurality of streams or stream segments in an upstream part of the primary flow passage such that a center flow axis of the stream or streams is aligned along the primary flow direction provided in the upstream part or spans with the primary flow direction an introduction angle of no more than 30°, preferably 20°, especially preferably 10°. Alternatively or in addition, the cool-air input device is formed such that the cool air introduced by the stream or streams at a stream expansion angle without previously flowing through the primary flow passage with multiple deflection of the primary flow direction by the inner walls of the cooler does not get into the secondary flow passage. The upstream part is understood as being a portion of the primary flow passage with uniform and deflection-free primary flow direction into which the working area of the stream or streams falls. In this way, it is ensured that the circulation flow along the primary flow direction around the refrigerated-goods container and the suction at the outlet of the secondary flow passage are not weakened by the introduced cool air.

Furthermore, a provision is made in a development of the proposed cooler that the cool-air input device has one or more outlet ports with edges for the passage of the cool air into an upstream part of the primary flow passage, and that a connecting line or connecting plane that extends from a respective edge facing toward a wall of the primary flow passage to this wall of the primary flow passage strikes this wall at an angle of no more than 17.5°, preferably 12.5°, especially preferably 5°.

Furthermore, a provision is made in a development of the proposed cooler that the cool-air input device has several outlet ports with edges for the passage of the cool air into an upstream part of the primary flow passage, and that, for two respective mutually adjacent outlet ports, two lines or planes that project from mutually adjacent edges of the mutually adjacent outlet ports, intersecting in the upstream part and forming together an angle of no more than 35°, preferably 25°, especially preferably 10°. Moreover, in a development of the proposed cooler, a provision is made that the cool-air input device has only one outlet port for the passage of the cool air into the primary flow passage, in which case the outlet port is formed as a slot extending along the direction of width, preferably over the entire width, of the primary flow passage. It is thereby achieved that the circulation flow emerging at a low flow velocity from the secondary flow passage flows only around the surface of the at least one refrigerated-goods container, particularly in the upstream part, while the cool air introduced at a high flow velocity as a stream or streams at a greater distance from the surface of the at least one refrigerated-goods container flows past the circulation flow. As a result of the introduced cool air flowing more quickly past, the circulation flow along the primary flow direction is created.

Moreover, in a development of the proposed cooler, a provision is made that the cool-air input device has several outlet ports for the passage of the cool air into the primary flow passage, in which case the outlet ports are along an axis running in the direction of width of the primary flow passage and are each formed as circular or slots and/or as ports projecting into the primary flow passage. It is preferred that all of the outlet ports be identical in terms of their type, alignment, and, especially preferably, dimensions. Furthermore, it is preferred that, in the case of slots in the direction of width of the primary flow passage in the upstream part, the sum of the respective widths of the outlet ports is less than the sum of the widths of the material surface layers. The several outlet ports make it possible for a portion of the circulation flow between the individual streams or stream segments of the introduced cool air emerging from the outlet ports to pass through and reach the side facing away from the at least one refrigerated-goods container. This enables the suction to be utilized on both sides of the overall flow, i.e., on the sides facing toward and facing away from the refrigerated-goods container.

The outlet ports of the latter two developments mentioned above can be formed as through holes in terms of a material cutout of a surface of the cool-air input device or as a port projecting spatially from a surface of the cool-air input device into the primary flow passage or into the upstream part whose diameter tapers, for example, in the direction of the primary flow direction provided in the upstream part.

As a continuation of the above development, a provision is made that the cool-air input device comprises a first plurality of slots running along a first axis extending in the direction of width of the primary flow passage, each with uniform longitudinal orientation in the direction of width or height of the primary flow passage, and that the cool-air input device also preferably comprises a second plurality of slots along a second axis extending in the direction of width of the primary flow passage that is spaced apart from the first axis in the direction of height of the primary flow passage, each with a preferably uniform longitudinal orientation transverse to the longitudinal orientation of the first plurality. Accordingly, in one embodiment, several uniformly spaced slot-like outlet ports are along the first axis facing toward the surface of the at least one refrigerated-goods container with its longitudinal orientation transverse to the first axis. In contrast, along the second axis facing away from the surface of the at least one refrigerated-goods container, several uniformly spaced slot-like outlet ports are with their longitudinal orientation along the second axis such that the portions of the circulation flow emerging from them that have flowed past the outlet ports associated with the first axis are deflected toward the introduced cool air, that is, in the direction of the primary flow direction. With this embodiment, a comb-like stream shape is produced, which intensifies the circulation flow.

Moreover, in a development of the proposed cooler, a provision is made that the cool-air input device has an outlet port for the passage of the cool air into the primary flow passage, in which case the outlet port is formed by an opened, closeable flap or lip of a temperature control device.

The temperature control is generally provided for the purpose of regulating the amount of cool air fed into the cooling compartment such that a desired temperature is achieved in the cooling compartment. Particularly in the event that a substantially higher temperature is desired in the cooling compartment, such as 8° C. for white wine or 14° C. for red wine, for example, in comparison to the cool air introduced at 0° C., the proposed cooler, due to the circulation flow of the heated air around the at least one refrigerated-goods container, offers the advantage that the heated air of the circulation flow mixes with the cool air introduced at a very low temperature relative to the target temperature, thus producing a homogeneous air temperature in the primary flow passage and in the secondary flow passage, i.e., around the at least one refrigerated-goods container. The temperature control is achieved by means of a movable flap or lip that allows air to be introduced into the primary flow passage in the opened state and blocks the cool air in the closed state.

According to the proposed development, this flap or lip of the temperature control is advantageously used as an outlet port or port for the jet-like introduction of the cool air into the primary flow passage, such that the movable flap or lip forms one of the tearing edges of the outlet port or port. When the cooling is shut off, the flap and therefore also the outlet port of the cool-air input device is closed, so that a screen in the outlet port, such as a fly screen, for example, can be omitted. Such a flap or lip can be opened or closed automatically by air pressure pending in the air supply duct, for example. Alternatively, the opening and closing of the flap or lip can be achieved by a mechanical or electric drive.

Furthermore, a provision is made in a development of the proposed cooler that the cool-air input device has an outlet port or several outlet ports for the passage of the cool air into the primary flow passage, each of which is formed as a port projecting into the primary flow passage that tapers particularly in the direction of its outlet port, and that an air-permeable screen with single bend or multiple bends is provided in the respective port upstream from the outlet port, i.e., before the cool air passes through the outlet port. By virtue of this design, a protective screen required for reasons of hygiene can be integrated into the cooler without adversely affecting the stream-like introduction of the cool air into the primary flow passage. Due to the bent shape of the screen, the speed of the air is less when passing through the screen than when the air emerges from the respective port.

Furthermore, in a development of the proposed cooler, a provision is made that the primary flow passage and the secondary flow passage are designed so as to be blower-free. The term “blower-free” is understood here as meaning particularly that both the primary flow passage and the secondary flow passage are free of a device that is designed to bring about or influence an airflow in the primary flow passage or the secondary flow passage with energy input. The circulation flow in the primary flow passage can thus be brought about and operated in an energy-efficient manner solely by the jet-like introduction of the cool air.

Moreover, in a development of the proposed cooler, a provision is made that the cooling compartment is designed to receive at least one parallepipedal refrigerated-goods container and is provided on at least one side inner wall of the cooling compartment with an upper holding and introducing device for holding and introducing the refrigerated-goods container, and that the upper holding and introducing device is provided with a passage for the cool air introduced into the primary flow passage to the side inner wall. The cooling of at least one side surface of the refrigerated-goods container is thus also achieved. A holding and introducing device without such a passage would have the effect that the side wall of the refrigerated-goods container cannot be flowed around with cool air, so the heat would reach the cooled refrigerated-goods container via the side outer wall. Since the side walls of the refrigerated-goods container are also flowed around by a portion of the cool air and the circulation flow as a result, the refrigerated-goods container is also cooled in a more homogeneous manner.

Moreover, in a development of the proposed cooler, a provision is made that the cooling compartment for receiving at least one parallepipedal refrigerated-goods container is designed whose upper-side wall, front-side wall, lower-side wall, and rear-side wall, together with the respectively opposing inner walls of the cooler, form the primary flow passage, and that the cooler further comprises at least one side wall cool-air input device associated with a side of the refrigerated-goods container to be cooled for feeding cool air to the cooling side wall. The side wall cool-air input device is provided in addition to the cool-air input device and outlet ports thereof and comprises at least one outlet port or port for supplying cool air to the side wall to be cooled. As a result, the circulation-like side-wall flow can be intensified or also generated independently of the cool air into the primary flow passage to be introduced cool-air input device. The cool air introduced through the side wall cool-air input device can be partially transferred into the primary flow passage after one or more circulations on the side wall or discharged through the hot-air extractor.

Furthermore, in a development of the proposed cooler, a provision is made that the cooling compartment is designed to receive a plurality of refrigerated-goods containers. A provision is also made that the primary flow passage and/or the secondary flow passage extend in their width (y direction) over all of the plurality of refrigerated-goods containers, and that the cool-air input device introduces the cool air into the primary flow passage in the manner of a stream for all of the plurality of refrigerated-goods containers. The aforementioned at least one refrigerated-goods container is thus formed by a plurality of refrigerated-goods containers.

Moreover, the present invention includes a cooler designed according to one of the above developments (or any combination thereof) together with at least one refrigerated-goods container designed for use with the cooler that is intended to be held in the cooling compartment or is received in the cooling compartment. The cooler can also be designed to receive a plurality of refrigerated-goods containers that are next to one another in the cooler when the cooler is used.

The invention also includes a method of cooling, particularly in an on-board kitchen of an aircraft, at least one refrigerated-goods container held in a cooler as described above, particularly a trolley, wherein cool air is introduced into the cooling compartment of the cooler, a cool-air stream is guided along a primary flow direction multiply deflected by the arrangement of the inner walls of the cooler around the at least one refrigerated-goods container, and heated air is discharged from the cooling compartment, and wherein the cool air is introduced in the manner of a stream into the primary flow passage along the primary flow direction, and a portion of the cool-air stream guided through the primary flow passage around the at least one refrigerated-goods container is returned through the secondary flow passage to the primary flow passage for the purpose of mixing with the introduced cool air and forming a circulation flow around the at least one refrigerated-goods container along the primary flow direction. Preferably, the cool air is introduced into the cooling compartment along the primary flow direction into the primary flow passage with a kinetic energy that is greater than a pressure loss that occurs as a result of the flowing-through of the primary flow passage and the secondary flow passage. In this way, it is ensured that, despite energy losses as a result of friction and deflections in the circulation passage composed of primary flow passage and secondary flow passage, a circulation flow around the at least one refrigerated-goods container can be produced and maintained.

The invention includes any combination of the developments described above.

### BRIEF DESCRIPTION OF THE DRAWING

To describe the proposed cooler, embodiments will now be described with reference to the following figures.

FIG. 1 shows an embodiment of the proposed cooler holding a refrigerated-goods container.

FIG. 2 is a three-dimensional view of the refrigerated-goods container, with the cooler being shown schematically in order to clearly show a primary flow direction.

FIG. 3 is a three-dimensional view of an embodiment of the proposed cooler.

FIG. 4 shows a detail of FIG. 3, namely a combined cool-air input device and hot-air extractor of an embodiment of the proposed cooler with a wide, slot-like outlet port.

FIG. 5 shows a sectional view of a combined cool-air input device and hot-air extractor of an embodiment of the proposed cooler with several through hole-type outlet ports.

FIG. 6 is a sectional view of a combined cool-air input device and hot-air extractor of an embodiment of the proposed cooler with several through slot-like outlet ports.

FIG. 7 is a sectional view of a combined cool-air input device and hot-air extractor of another embodiment of the proposed cooler with several slot-like outlet ports.

FIG. 8 is a sectional view of a combined cool-air input device and hot-air extractor of another embodiment of the proposed cooler with several nozzles as outlet ports.

FIG. 9 is a sectional view of a combined cool-air input device and hot-air extractor of another embodiment of the proposed cooler with a first and a second plurality of outlet ports.

FIG. 10 is a three-dimensional view of another embodiment of the proposed cooler.

FIG. 11 is a detail of FIG. 10, namely a combined cool-air input device and hot-air extractor of an embodiment of the proposed cooler with a wide, slot-like outlet port.

FIG. 12 is another embodiment of the proposed cooler with a refrigerated-goods container held therein and angled introduction of the cool air.

FIG. 13 is another embodiment of the proposed cooler with a refrigerated-goods container held therein and angled introduction of the cool air via a closeable flap.

FIGS. 14A and 14B each show an embodiment of a port as part of a cool-air input device with an integrated screen according to other embodiments of the proposed cooler.

FIGS. 15A and 15B show another embodiment of the proposed cooler with guides for side-wall flow.

FIGS. 16A and 16B show another embodiment of the proposed cooler with a separate side-wall cool-air input device.

FIG. 17 is another embodiment of the proposed cooler with spaced-apart cool-air input device and hot-air extractor.

FIGS. 18A, 18B, and 18C show embodiments of the proposed cooler with at least one outlet port with edges for the passage of cool air into an upstream part of the primary flow passage.

FIG. 19 is another embodiment of the proposed cooler that is related to the embodiment shown in FIG. 18C.

FIG. 20 is an embodiment of the proposed cooler that is designed to hold a plurality of refrigerated-goods containers.

FIG. 21 is an embodiment of the proposed cooler with an intermediate wall for forming the secondary flow passage.

FIG. 22 is another embodiment of the proposed cooler.

FIG. 23 is a known cooler according to the prior art as the starting point for the present invention.

In the figures shown, identical or similar components are designated with the same reference symbols throughout.

### EMBODIMENTS OF THE INVENTION

FIG. 1 is a view (not to scale) of an embodiment of the proposed cooler with a refrigerated-goods container held therein. The cooler 1 has a cooling compartment 2 having a substantially parallepipedal shape formed by its inner walls 12, 13, 14, and 15 and two other inner walls (not shown) and holding a substantially parallepipedal refrigerated-goods container 20 with wheels 21 that is designed for use as a trolley in aircraft. Furthermore, the cooler 1 comprises a cool-air input device 3 with an outlet opening or port 5 for introducing a free jet of cool air centered on a flow axis 5A with an expansion angle or spread angle 6 in an upstream part 7 of a primary flow passage. The primary flow passage is formed by a row of primary flow passage portions each formed by an inner wall 12, 13, 14, 15 of the cooler 1 and an outer wall 22, 23, 24, 25 of the refrigerated-goods container 20 opposite the respective inner wall, as well as two side inner walls (not shown) of the cooler 1. The primary flow through the primary flow passage is deflected and/or guided by the inner walls 12 to 15 of the cooler 1 along the primary flow directions 8-2, 8-3, 8-4, and 8-5 (coordinates or general designation: x). The air flowing along the primary flow direction 8-5 is divided up in the primary flow passage portion of the walls 15 and 25. A portion 98 thereof is discharged from the cooling compartment 2 by a hot-air extractor 4. Another portion 9A is returned as a secondary flow through a secondary flow passage 9 to the upstream part 7 or aspirated into the upstream part 7 by the suction or negative pressure prevailing in the upstream part 7 that is caused by the cool air being introduced at a high flow velocity. This portion of the airflow that is flowed or flows through the secondary flow passage 9 forms a circulation flow 97 mixing with the flow of introduced cool air. Accordingly, the primary flow passage that is formed by the inner walls 12 to 15 of the cooler 1 and the outer walls 22 to 25 of the refrigerated-goods container 20 with the primary flow direction x, and the secondary flow passage 9 that is formed by a portion of the outer wall 25 of the refrigerated-goods container 20 and an outer wall 4A of the hot-air extractor 4, possibly also by an adjacent portion of an outer wall of the cool-air input device 3, form a circulation passage around the refrigerated-goods container 20. The flow in this circulation passage is aligned in the primary flow direction.

As shown in FIG. 1, the expansion angle 6 of the stream of cool air emerging from the outlet port 5 is such that the cool air is not introduced counter to the primary flow direction x or 8-2 into the primary flow passage, and such that the flanks of the stream or the flow boundaries 6F, 6G completely cover the connection between the secondary flow passage and the primary flow passage. At the boundaries 6F, 6G determined by the spread angle 6, the flow velocity of the introduced cool air in the primary flow direction is approximately zero or is less than 1% of the maximum velocity. At position x0 of the upstream part, the stream of introduced cool air extends over the entire cross section of the primary flow passage.

The cool-air input device 3 and the hot-air extractor 4 are spaced from one another in the cooling compartment 2 so as to be at the corner of adjacent inner walls 12 and 15 of the cooler 1, with the primary flow direction x being deflected by the cool-air input device 3 and the hot-air extractor 4.

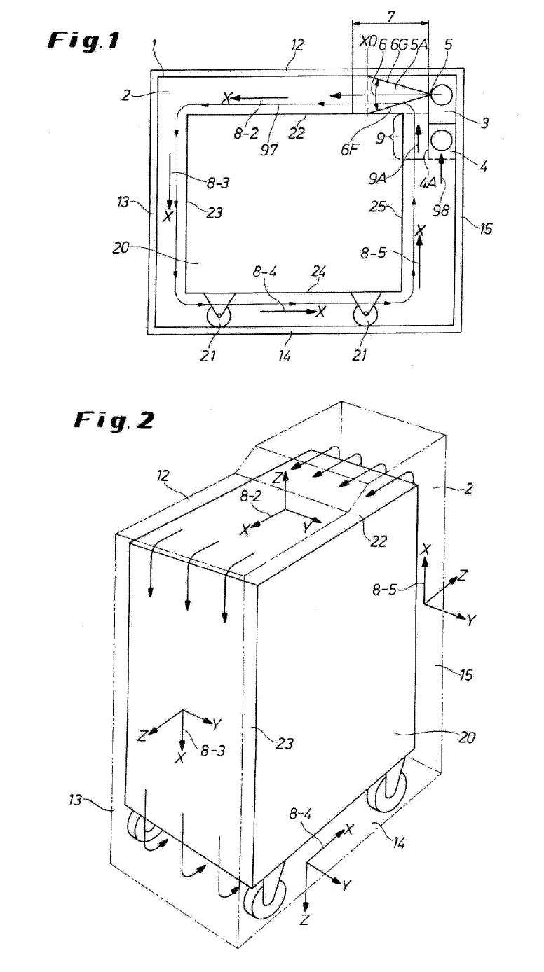

FIG. 2 is a three-dimensional view of the refrigerated-goods container 10 held in the cooling compartment 2 (indicated by broken lines). FIG. 2 illustrates the deflections of the primary flow direction x as a result of the arrangement of the inner walls of the cooler 1. A width y of the primary flow passage or of one of the portions thereof is indicated by the dimension transverse to the primary flow direction x. The height z of the primary flow passage or of one of the portions thereof indicates the distance between each inner wall 12, 13, 14, 15 of the cooler 1 and the respective opposite outer wall 22, 23, 24, 25 of the refrigerated-goods container 20.

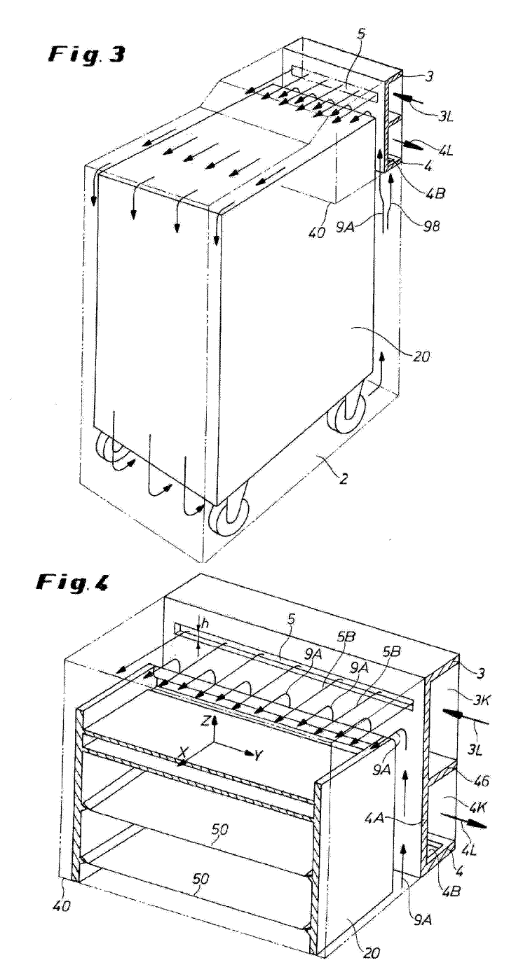

FIG. 3 is approximately a three-dimensional view of the cooler 1 shown in FIG. 1 with the refrigerated-goods container 20 held therein. In particular, FIG. 3 illustrates an embodiment of the cool-air input device 3 and the hot-air extractor 4.

FIG. 4 is an enlarged illustration of the region indicated at 40 in FIG. 3 and shows the mixing of the cool air freshly introduced through the outlet port 5 (arrows 5B) and the air of the secondary flow (arrows 9A) in the upstream part of the primary flow passage. The outlet port 5 is formed as a slot with the height h extending over nearly the entire width (y direction) of the primary flow passage. The cool-air input device 3 and the hot-air extractor 4 form a combined air supply/extraction passage, with an air supply duct 3K of the cool-air input device 3 for feeding in cool air 3L and an air discharge passage 4K of the hot-air extractor 4 for extracting heated air 4L that is fed through an output port 4B into the air discharge passage 4K separated by a partition 46. As shown in FIG. 4, the air of the secondary flow represented by the bent arrows 9A is fed into the cool air 5B. Together, these form a circulation flow 97 in the primary flow direction x.

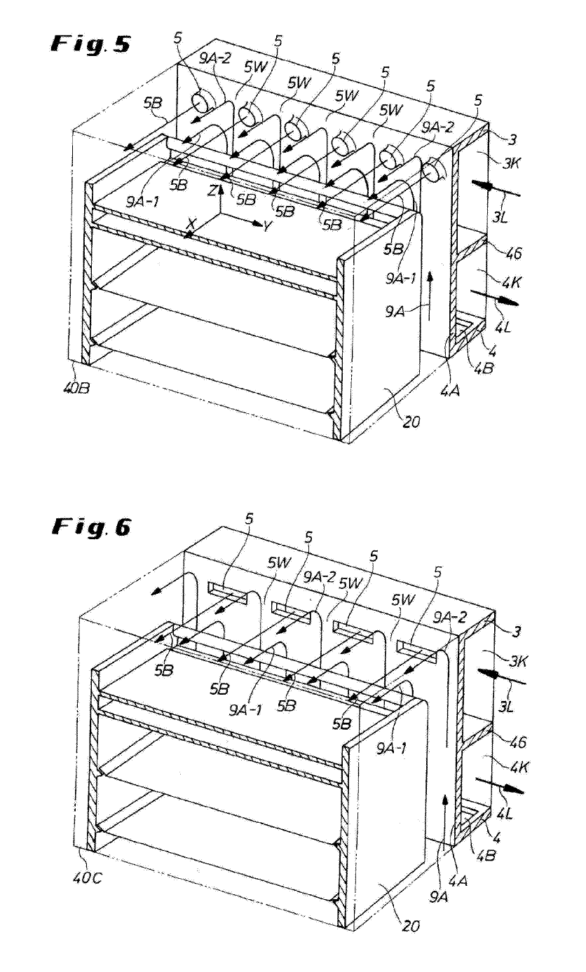

FIGS. 5 to 9 show other embodiments for the cool-air input device 3 that, instead of the wide slot shown in FIG. 4, have a plurality of outlet ports 5.

In the cool-air input device 3 shown in FIG. 5, several outlet ports 5 are identical circular throughgoing holes of equal size that are equispaced apart from one another. Due to the through holes as outlet ports 5, spaced apart by intermediate wall portions 5W and through which the freshly introduced cool air (arrows 5B) flows into the upstream part of the primary flow passage, the air of the secondary flow is conducted both below (arrows 9A-1) the cool air 5B and hence in the vicinity of the outer wall of the refrigerated-goods container 20 and, when seen in the z direction, above (arrows 9A-2) the cool air 5B. The intermediate wall portions 5W make it possible for a portion of the secondary flow 9A to be conducted above the cool air 5B introduced in the manner of a stream segment.

The cool-air input device 3 shown in FIG. 6 has several outlet ports 5 that are equispaced slots through intermediate wall portions 5W that are elongated parallel to the width of the primary flow passage (y direction). The air of the secondary flow is conducted both below (arrows 9A-1) the cool air 5B and above (arrows 9A-2) the cool air 5B.

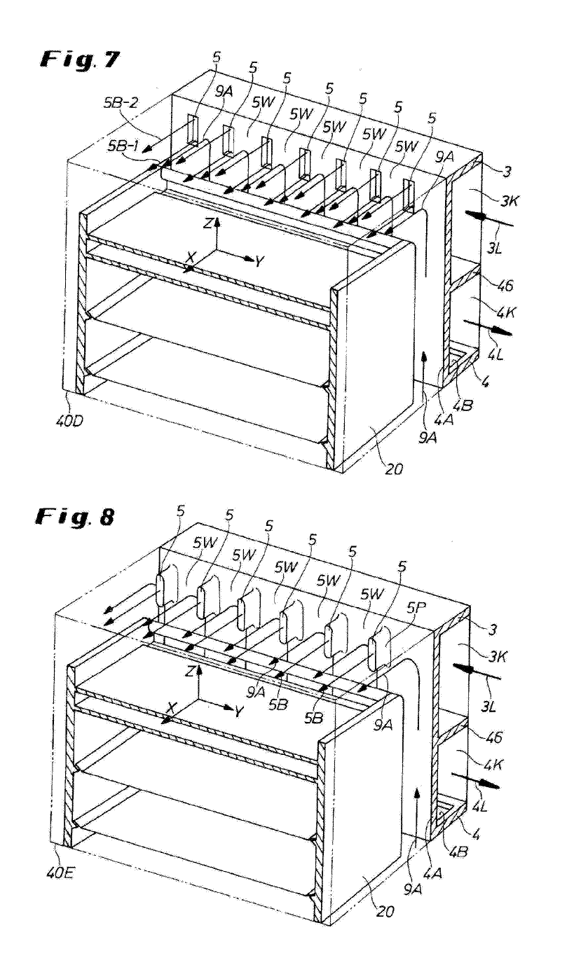

The cool-air input device 3 shown in FIG. 7 has several outlet ports 5 that are equispaced slots separated by intermediate wall portions 5W and that are elongated parallel to the height of the primary flow passage (z direction). The freshly introduced cool air is introduced into the upstream part as a plurality of streams that each extend from the outer wall of the refrigerated-goods container 20 (arrows 5B-1) to the inner wall of the cooler (arrows 5B-2). The air of the secondary flow 9A reaches the areas of the intermediate wall portions 5W between the streams of the introduced cool air and is entrained by same.

The cool-air input device 3 shown in FIG. 8 has several outlet ports 5 that are equispaced ports 5P projecting through intermediate wall portions 5W in the primary flow direction x. In the areas of the intermediate wall portions 5W, the air of the secondary flow 9A can flow behind the nozzles 5P (when seen in the x direction) in order to then be entrained by the freshly introduced cool air.

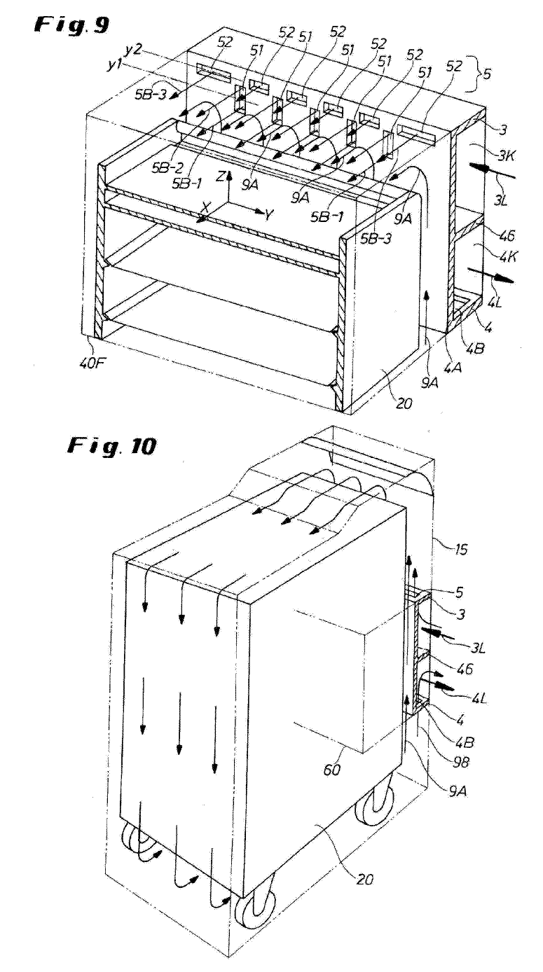

As an arrangement of outlet ports 5, the cool-air input device 3 shown in FIG. 9 has a combination of the arrangements of slots shown in FIGS. 6 and 7. A first plurality of uniformly spaced slots 51, each elongated in the direction of height (z direction) of the primary flow passage, is along a first axis y1 running in the direction of width of the primary flow passage. In addition, a second plurality of uniformly spaced slots 52, each elongated in the direction of width (y direction) of the primary flow passage, is along a second axis y2 running in the direction of width of the primary flow passage that is spaced apart from the first axis and faces toward the adjacent inner wall of the cooler. The arrangement of the openings 51 and 52 forms an overall comb-like outlet port. Accordingly, the cool air is introduced with a comb-like flow profile into the upstream part that is shown in FIG. 9 by the arrows 5B-1 and 5B-2 associated with the outlet ports 51 and the arrows 5B-3 associated with the outlet ports 52, with these arrows being analogous to the “teeth” of the comb and the connecting members thereof. The air of the secondary flow 9A is entrained analogously in the recesses of the “teeth” by the suction of the cool air 5B-1, 5B-2, and 5B-3 flowing quickly past.

The sectional views of FIGS. 10 and 11 show an embodiment of the cooler in which the cool-air input device 3 and the hot-air extractor 4 form a combined air supply/air discharge passage, with the cool-air input device 3 and the hot-air extractor 4 being mounted on the front inner wall 15 of the cooler 1 and removed from a place in which the primary flow direction is deflected. The air of the secondary flow represented by the arrows 9A and the cool air (represented by the arrow 5B) freshly introduced through the wide slot travel in the same direction. The outer wall of the cool-air input device 3 and the hot-air extractor 4, together with a portion of the outer wall of the refrigerated-goods container 20, form the secondary flow passage.

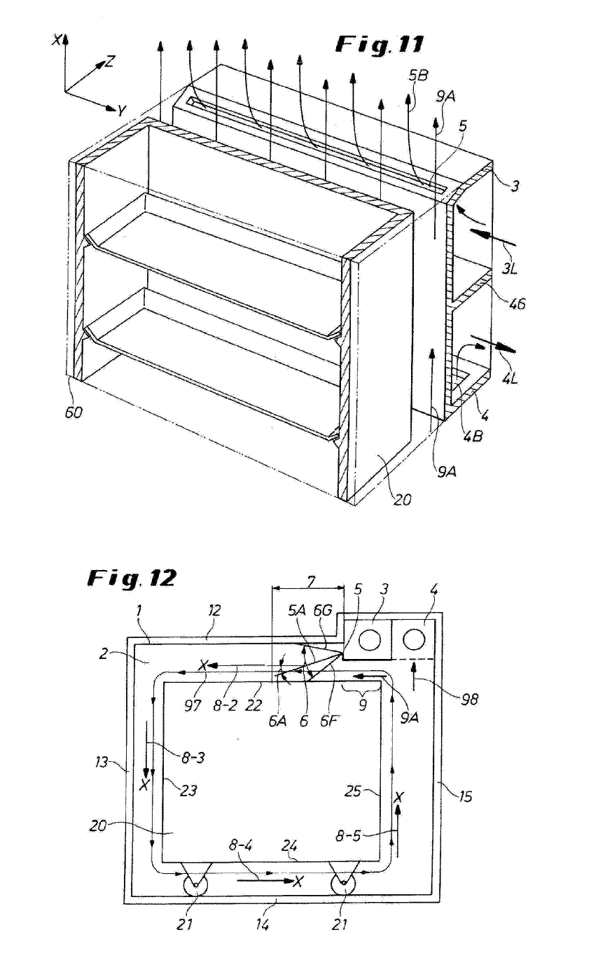

FIG. 12 is a view (not to scale) of an embodiment of the proposed cooler holding a refrigerated-goods container. Unlike the embodiment shown in FIG. 1, the cooler shown in FIG. 12 introduces a stream of cool air along a center flow axis 5A that forms an introduction angle 6A of less than 20° with the primary flow direction 8-2 in the primary flow passage formed by the inner wall 12 and the outer wall 11. The outlet port 5 is formed such that the cool air is not introduced counter to the primary flow direction into the primary flow passage, and such that the flank of the stream or the flow boundary 6F completely covers the connection between the secondary flow passage 9 and the primary flow passage. The flow boundary 6F then forms a plane of negative pressure extending completely in the y direction and the z direction, with the result that only heated air is fed from the secondary flow passage to the stream of cool air.

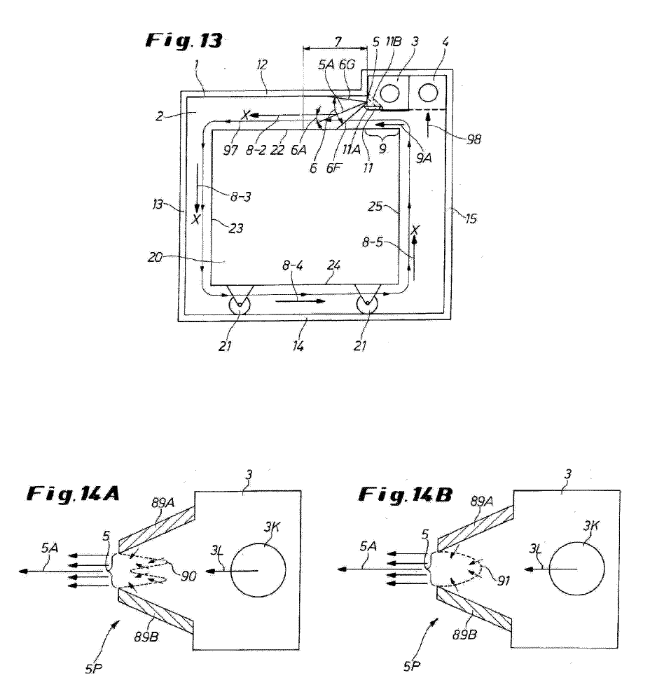

FIG. 13 is another embodiment of the proposed cooler as a variation of the embodiment shown in FIG. 12. The cooler 1 shown in FIG. 13 has an outlet port 5 that is formed by a clipped-off edge 11A of an opened closeable flap 11 of a temperature control device (not shown in its entirety). In a closed position 11B of the closeable flap 11, the outlet port 5 is blocked, so that the cool-air input device 3 cannot introduce any cool air into the primary flow passage.

FIGS. 14A and 14B each show an embodiment of a port 5P formed by converging outer walls 89A, 89B with an outlet port 5 as part of a cool-air input device 3 according to other embodiments of the proposed cooler. A bent, air-permeable screen 90 or 91 is provided upstream of the outlet opening in the port according to FIGS. 14A and 14B, with the bend apex or a plurality of bend apexes of the screen facing away from the outlet port 5 and thus aligned against the direction of flow, and with the ends of the screen 90 and 91 mounted at the ends of the outer walls 89A, 89B forming the outlet port, so that the screen surface is greater than the port cross section.

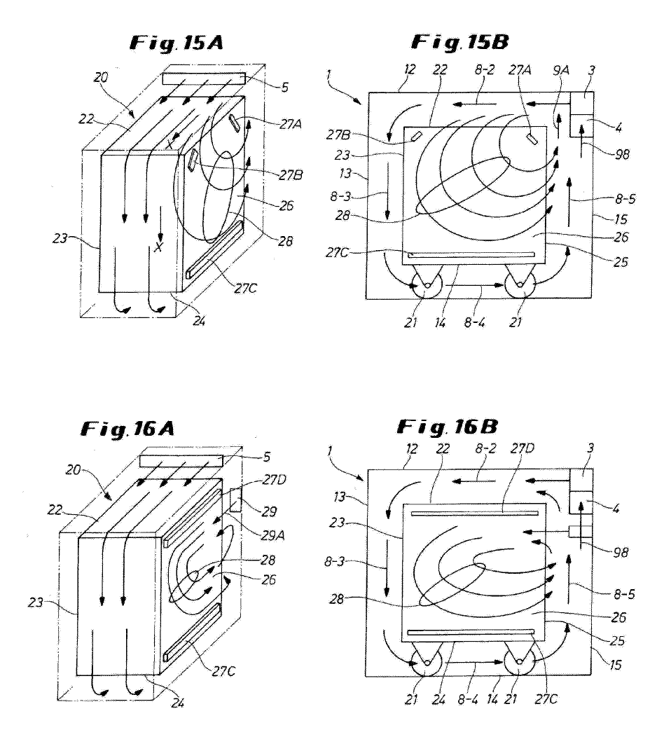

FIGS. 15A, 15B, 16A, and 16B each show a different embodiment of the proposed cooler holding a parallepipedal refrigerated-goods container. For a side wall 26 of the parallepipedal refrigerated-goods container 20, multiple upper guides 27A and 27B (FIGS. 15A and 15B) or one upper guide 27D (FIGS. 16A and 16B) and a lower guide 27C are provided to guide a side-wall flow 28. These guides are mounted on the inner wall of the cooler 1 that faces the side wall 26 thereof when used in conjunction with the refrigerated-goods container 20. As shown in FIGS. 15A and 15B, the upper guides 27 and 27B are mounted in the vicinity of the upper corners of the side wall 26 in order to deflect the air flowing along the primary flow direction 8-2 at the edges of the upper-side wall 22 of the refrigerated-goods container 20 such that the side-wall flow 28 flows in a circulating manner past the side wall 26 with cool air. As shown in FIGS. 15A, 15B and FIGS. 16A, 16B, the guide 27C for introducing and holding the refrigerated-goods container 20, which is a trolley, extending longitudinally along the lower edge of the side wall 26 is also mounted in the vicinity of the lower end of the side wall 26 in both embodiments.

While the side wall 26 is flowed around in the embodiment of FIGS. 15A, 15B by cool air fed in via the outlet port 5, a portion of which is conducted in the primary flow passage, a side wall cool-air input device 29 that is separate from the cool-air input device 3 and the outlet port thereof and can also be coupled with or connected to the cool-air input device 2 is provided in order to introduce cool air along the side wall flow direction 29A of the side wall 26 to be cooled.

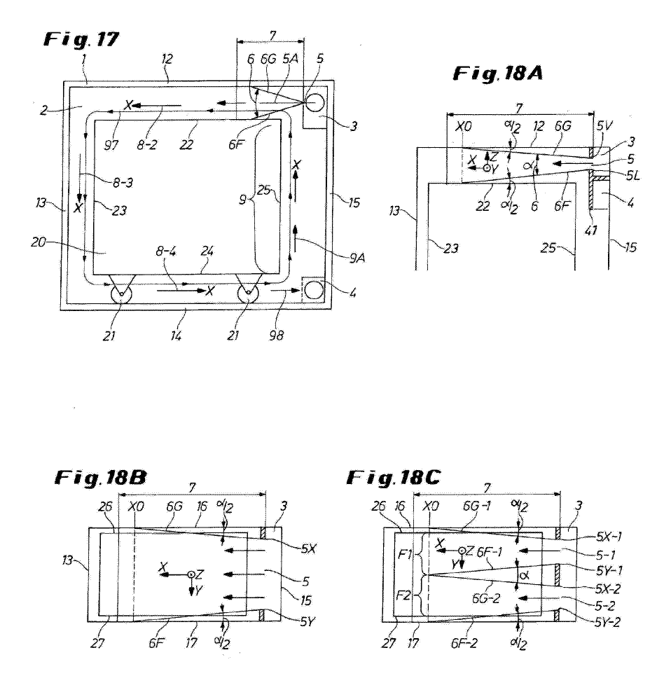

FIG. 17 is another embodiment of the proposed cooler with a refrigerated-goods container held therein. Unlike the previous embodiments, the cool-air input device 3 and the hot-air extractor 4 are in opposing corners of the cooling compartment and hence at a distance from one another. The hot-air extractor 4 is on the bottom surface 14 of the cooling compartment 2, and a portion 98 of the heated air is discharged from the cooling compartment 2 via the hot-air extractor 3, whereas another portion flows as a secondary flow 9A through the secondary flow passage 9 that is formed between the outer wall 25 and the inner wall 15. When the cooler is used with the refrigerated-goods container 20 provided for this purpose, a circulation flow 97 forms along the outer walls 22 to 25 of the refrigerated-goods container 20.

FIGS. 18A, 18B, and 18C show embodiments of the proposed cooler with at least one outlet port with edges for the passage of cool air into an upstream part of the primary flow passage. FIGS. 18A and 18B show a side view and top view, respectively, of an embodiment of a cooler with a cool-air input device 3 that has an outlet port 5 with an upper edge 5U and a lower edge 5L extending as a slot from the first edge 5X along the width y of the primary flow passage to a second edge 5Y. FIG. 18C is a top view of an embodiment of a cooler with a cool-air input device 3 that has two outlet ports 5-1 and 5-2 with edges 5X-1, 5Y-1 and 5Y-1, 5X-2, respectively, for the passage of the cool air. Something that all of the shown embodiments have in common is that a connecting line or connecting plane that extends from a respective edge facing a wall of the primary flow passage to this wall of the primary flow passage strikes this wall at an angle of α/2 (where a is no more than 35°, preferably no more than 25°, and especially preferably) 10°). The connecting line 6G (6F) that starts from the edge 5U (5L) that faces toward the inner wall 12 of the cooling compartment (the outer wall 22 of the refrigerated-goods container), strikes the inner wall 12 (outer wall 22) at an angle of no more than α/2 in position x0. The connecting line 6G (6F) that starts from the edge 5X (5Y) that faces toward the side inner wall 16 of the cooling compartment (the side inner wall 17 of the cooling compartment), strikes the side inner wall 16 (inner wall 17) at an angle of no more than α/2 in position x0. The connecting line 6G-1 (6F-2) that starts from the edge 5X-1 (5Y-2) that faces toward the side inner wall 16 of the cooling compartment (the inner wall 17 of the cooling compartment), strikes the side inner wall 16 (inner wall 17) at an angle of no more than α/2 in position x0. It is also shown in FIG. 18C that, for two respective mutually adjacent outlet ports 5-1 and 5-2, two lines or planes 6F-1 and 6G-2 that emanate from mutually adjacent edges 5Y-1 and 5X-2 of the mutually adjacent outlet ports 5-1 and 5-2, intersect in the upstream part 7 at position x0 and form an angle with one another (maximum of 35°, preferably maximum of 25°, and especially preferably maximum of) 10°). Something that all of the embodiments of FIGS. 18A, 18B, and 18C have in common is that the stream or streams for introducing cool air in position x0 in the upstream part fills or fill out the cross section of the primary flow passage transverse to the x direction completely, with the primary flow direction x experiencing no deflection in the upstream part 7 at least up to position x0. In the embodiment shown in FIG. 18C with two outlet ports 5-1 and 5-2, the cross section of the primary flow passage transverse to the primary flow direction x is filled out completely in position x0 by two mutually adjacent or overlapping flow sub-portions F1 and F2, each of which is associated with a respective outlet port 5-1 or 5-2.

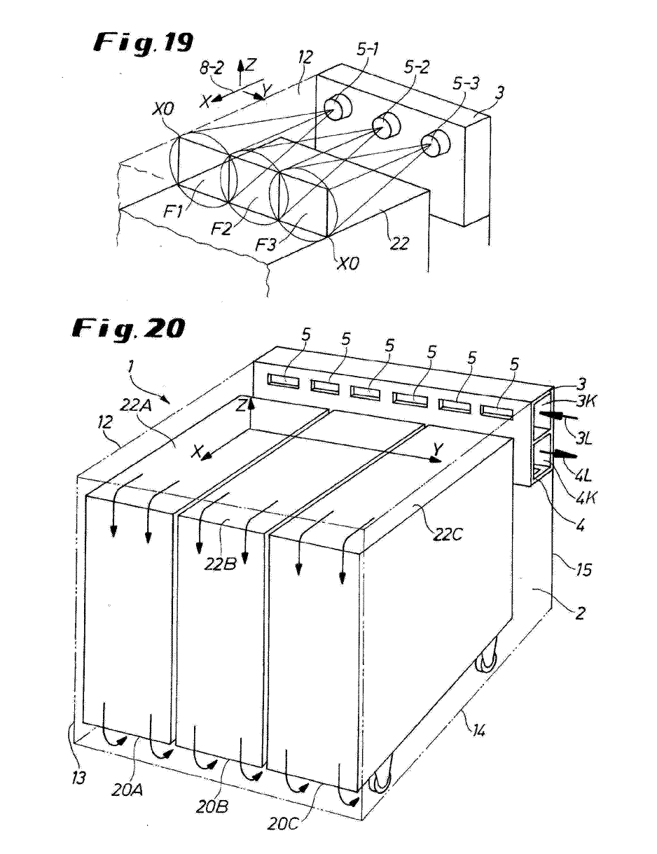

FIG. 19 is a three-dimensional view of a detail of an embodiment of a proposed cooler with three outlet ports 5-1, 5-2, and 5-3. Like the embodiment shown in FIG. 18C, the cross section of the primary flow passage transverse to the primary flow direction x is filled out completely at position x0 in the upstream part by three stream sub-portions F1, F2, and F3, each of which is associated with a respective outlet port 5-1, 5-2, or 5-3, with the stream sub-portions F1, F2 and F2, F3 associated with the neighboring outlet ports 5-1, 5-2 and 5-2, 5-3, respectively, being mutually adjacent or overlapping.

FIG. 20 is another embodiment of the proposed cooler in a three-dimensional view. The cooler 1 is designed to receive a plurality of refrigerated-goods containers 20A, 20B, and 20C next to one another in the cooling compartment 2, each of which embodies a trolley provided for use in aircraft. The cool-air input device 3 is provided over the entire width (y direction) of the primary flow passage with outlet ports 5 for introducing cool air into the upstream part of the primary flow passage. In at least one position in the upstream part, and before a deflection of the primary flow direction by an inner wall of the cooler, the air streams emerging from the outlet ports 5 of the cool-air input device 3 fill out the entire width (y direction) and the entire height (z direction of the primary flow passage. The secondary flow passage preferably extends over all of the refrigerated-goods containers 20A, 20B, and 20C.

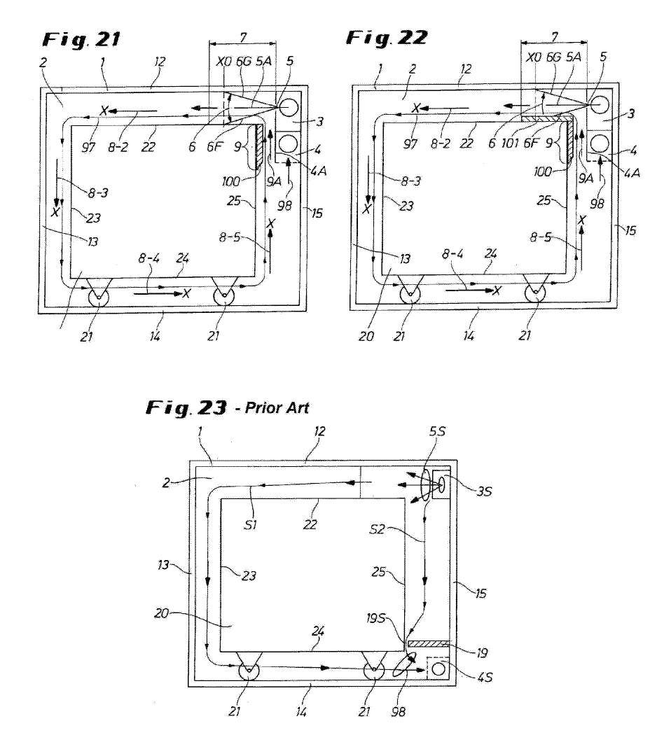

FIG. 21 is another embodiment of the proposed cooler. Unlike the embodiment shown in FIG. 1, an intermediate wall 100 is provided in the cooling compartment 2. For the purpose of forming the secondary flow passage 9 for the passage of the secondary flow, the intermediate wall 100 is provided at a distance to the outer wall 4A of the hot-air extractor 4. When the refrigerated-goods container 20 is introduced into the cooling compartment 2 and positioned therein for use in its intended storage position, the outer wall 25 of the refrigerated-goods container 20 abuts the side of the intermediate wall 100 facing away from the outer wall 4A of the hot-air extractor 4.

FIG. 22 is another embodiment of the proposed cooler. Unlike the embodiment shown in FIG. 21, an airflow guiding wall 101 is provided in the cooling compartment 7. The airflow guiding wall 101 extends in the upstream part 7 along the provided primary flow direction or in the direction of the center flow axis 5A of the introduced cool air and is adjacent to and along the upper-side wall 22 of the refrigerated-goods container 20 and opposite the inner wall 12 of the cooling compartment 2. The flow boundary 6F of the introduced cool air strikes the airflow guiding wall 101. The airflow guiding wall 101 is formed together with the intermediate wall 100 as a rectangular component bordered by the refrigerated-goods container 20 introduced into the cooling compartment 2 into a specified position with its side wall 25 and its upper-side wall 22.

### LIST OF REFERENCE SYMBOLS

1 cooler

2 cooling compartment

3 cool-air input device

3K air supply duct

3L cool air

4 hot-air extractor

4A outer wall of the hot-air extractor

4B output port

4K air discharge duct

4L heated air

5, 5-1, 5-2, 5-3 outlet port or port

5A center flow axis

5B introduced cool air

5L, 5U, 5X, 5Y edge of outlet port

5P port

6 expansion angle or spread angle

6A introduction angle

6F, 6G flow edge or flow boundary

7 upstream part

8-2, 8-3, 8-4, 8-5 primary flow direction

9 secondary flow passage

9A secondary flow

12,4013, 14, 15, 16, 17 inner wall of the cooler

20 refrigerated-goods container

21 wheel

22, 23, 24, 25, 26, 27 outer wall of the refrigerated-goods container

27A, 27B, 27C, 27D holding and guiding device

46 partition

89A, 89B port outer wall

90, 91 screen

97 circulation flow

98 exhaust air

100 intermediate wall

101 airflow guiding wall angle

F1,15F2, F3 flow sub-area

x primary flow direction

x0 position of full air introduction

y direction of width of the primary flow passage

z direction of height of the primary flow passage

1. In a cooler for an on-board kitchen of an aircraft and having:
a cooling compartment defined by inner walls of the cooler for receiving a refrigerated-goods container;
a cool-air input device for introducing cool air into the cooling compartment; and
a hot-air extractor for discharging heated air from the cooling compartment, wherein, when used in conjunction with the a refrigerated-goods container in the cooling compartment, the inner walls of the cooler and outer walls of the a refrigerated-goods container form a primary flow passage for guiding a cool-air stream along a primary flow direction multiply deflected by the inner walls from the cool-air input device around the a refrigerated-goods container to the hot-air extractor is formed,
the improvement wherein the cool-air input device introduces the cool air into the primary flow passage along a primary flow direction in the form of a stream, and a secondary flow passage is formed in the cooling compartment in order to return, as a secondary flow, a portion of the cool-air stream guided by the primary flow passage around the a refrigerated-goods container to the primary flow passage for the purpose of mixing with the introduced cool air and forming a circulation flow around the a refrigerated-goods container along the primary flow direction.

2. The cooler defined in claim 1, wherein the cool-air input device and the hot-air extractor are mounted on one or two of the inner walls of the cooler so as to be adjacent to one another, and or the cool-air input device or the hot-air extractor is on two mutually adjacent inner walls of the cooler for deflecting the primary flow direction, or or the cool-air input device and the hot-air extractor form a combined air supply/discharge device.

3. The cooler defined in claim 1, wherein the secondary flow passage is formed by one of the outer walls of the a refrigerated goods container and an outer wall of the hot-air extractor or an outer wall of the cool-air input device.

4. The cooler defined in claim 1, wherein the secondary flow passage is formed by an intermediate wall provided in the cooling compartment and an outer wall, spaced apart therefrom, of the hot-air extractor or an outer wall of the cool-air input device.

5. The cooler defined in claim 1, wherein the cool-air input device introduces the cool air as a stream or as a plurality of streams in an upstream part of the primary flow passage over an entire width and an entire height of the primary flow passage in the upstream part, and or the upstream part is formed without a deflection of the primary flow direction by the arrangement of the inner walls of the cooler, or at least with a deflection of the primary flow direction that does not exceed 25°.

6. The cooler defined in claim 5, further comprising:
an airflow guiding wall for conducting the introduced cool air is in the upstream part, and or the airflow guiding wall, when used in conjunction with the a refrigerated-goods container, is adjacent thereto.

7. The cooler defined in claim 5, wherein a flow boundary of the stream or flow boundaries of the plurality of streams is or are facing toward the secondary flow passage and completely fills or fill out a plane perpendicular to the primary flow direction in the upstream part.

8. The cooler defined claim 1, wherein the cool-air input device introduces the cool air as a stream or as a plurality of streams or stream segments in an upstream part of the primary flow passage such that a center flow axis of the stream or streams is aligned along the primary flow direction or spans with the primary flow direction an introduction angle of no more than 30°.

9. The cooler defined in claim 1, wherein the cool-air input device has one or more outlet ports with edges for the passage of the cool air into an upstream part of the primary flow passage, and or a connecting line or connecting plane that extends from a respective edge facing toward this wall of the primary flow passage to this wall of the primary flow passage strikes this wall at an angle of no more than 17.5°.

10. The cooler defined in claim 1, wherein the cool-air input device has several outlet ports with edges for the passage of the cool air into an upstream part of the primary flow passage, and, for two respective mutually adjacent outlet ports, two lines or planes that project from mutually adjacent edges of the mutually adjacent outlet ports, intersecting in the upstream part and forming together an angle of no more than 35°.

11. The cooler defined in claim 1, wherein the cool-air input device has an outlet port that is formed as a slot extending along the direction of width of the primary flow passage, over the entire width, and is formed as a port projecting into the primary flow passage.

12. The cooler defined in claim 1, wherein the cool-air input device has several outlet ports that are along an axis running in the direction of width of the primary flow passage and are each formed as a circular or slot or as a port projecting into the primary flow passage.

13. The cooler defined in claim 11, claim 1, wherein the cool-air input device comprises a first plurality of slots running along a first axis extending in the direction of width of the primary flow passage, each with uniform longitudinal orientation in the direction of width or height of the primary flow passage, and the cool-air input device also comprises a second plurality of slots along a second axis extending in the direction of width of the primary flow passage, each with a uniform longitudinal orientation transverse to the longitudinal orientation of the first plurality.

14. The cooler defined in claim 1, wherein the cool-air input device has an outlet port for the passage of the cool air into the primary flow passage, with the outlet port being formed by an opened, closeable flap or lip of a temperature control device.

15. The cooler defined in claim 1, wherein the cool-air input device has one outlet port or several outlet ports for the passage of the cool air into the primary flow passage, and or an air-permeable screen with single bend or multiple bends is provided upstream from the outlet port.

16. The cooler defined in claim 1, wherein the primary flow passage and the secondary flow passage are blower-free.

17. The cooler defined in claim 1, wherein the cooling compartment is designed to receive a parallepipedal refrigerated-goods container and is provided on a side inner wall of the cooling compartment with an upper holding and introducing device for holding and introducing the refrigerated-goods container, and or the upper holding and introducing device is provided with a passage for the cool air introduced into the primary flow passage to the side inner wall.

18. The cooler defined in claim 1, wherein the cooling compartment is designed to receive a parallepipedal refrigerated-goods container and the refrigerated-goods container further comprises a side wall cool-air input device associated with a side wall of the a refrigerated-goods container for feeding cool air to the cooling side wall.

19. The cooler defined in claim 1, wherein the cooling compartment is designed to receive a plurality of refrigerated-goods containers, or the primary flow passage or the secondary flow passage extends in its width over all of the plurality of refrigerated-goods containers, and or the cool-air input device introduces the cool air into the primary flow passage for all of the plurality of refrigerated-goods containers.

20. (canceled)

21. A method of cooling in an on board kitchen of an aircraft a refrigerated-goods container held in a cooler, the method comprising the steps of:
introducing cool air into the cooling compartment of the cooler,
guiding a cool-air stream along a primary flow direction multiply deflected by the arrangement of the inner walls of the cooler around the a refrigerated-goods container, and heated air is discharged from the cooling compartment,
introducing the cool air in the manner of a stream into the primary flow passage along the primary flow direction, and or
recirculating a portion of the cool-air stream guided through the primary flow passage around the a refrigerated-goods container through the secondary flow passage to the primary flow passage for mixing with the introduced cool air and forming a circulation flow of the cool air and the recirculated cool air around the a refrigerated-goods container along the primary flow direction.
